(19) United States
(12) Patent Application Publication
(10) Pub. No.: US 2005/0132625 A1
(43) Pub. Date: Jun. 23, 2005

(54) Sign housing and assembly

(76) Inventor: Charles P. Schwester, Kinnelon, NJ (US)

Correspondence Address: KAPLAN & GILMAN , L.L.P., 900 ROUTE 9 NORTH, WOODBRIDGE, NJ, 07095, US

(21) Appl. No.: 11/019,599

(22) Filed: Dec. 22, 2004

Related U.S. Application Data
(60) Provisional application No. 60/532,216, filed on Dec. 23, 2003.
(60) Provisional application No. 60/628,471, filed on Nov. 16, 2004.

(51) Int. Cl. G09F 13/04

(52) U.S. Cl. 40/564

(57) ABSTRACT

A sign housing and adapted to receive a mock neon sign assembly. In one embodiment, the sign housing comprises two pieces including a first piece comprising the sides and the rear panel, and a second piece shaped to meet the peripheral edges of the sides of the first piece. An assembly including a housing and mock neon sign, the mock neon sign including a rear board having a light source, a middle panel overlying the rear board and including one or more shaped areas having configurations that complement the arrangement of the light source, and a front panel overlying the middle panel including a corresponding shaped area that permits light from the aforementioned light source to pass therethrough.

### CROSS REFERENCE TO RELATED APPLICATIONS

This application claims the benefit of U.S. Provisional Patent Application Ser. No. 60/532,216, entitled “SIGN ASSEMBLY” filed Dec. 23, 2003, and U.S. Provisional Patent Application Ser. No. 60/628,471, entitled “SIGN ASSEMBLY” filed Nov. 16, 2004, the entire disclosures of which are hereby incorporated herein by reference.

### TECHNICAL FIELD

The present invention is directed to a sign housing and, more particularly, to a sign housing for a mock neon sign and assembly thereof.

### BACKGROUND OF THE INVENTION

For most businesses operating in a storefront, whether it be on a street, in a shopping mall or otherwise, signage is an important business tool. Every such business requires signage suitable to identify the business and ideally create a favorable and inviting impression. For many businesses a neon sign is the signage of choice. Unfortunately, neon signs are expensive to purchase, are prone to breakage during shipping and in use and are costly to repair. Moreover, when repairs are required a business must often do without adequate or desirable signage during a possibly lengthy repair process.

To date, mock neon signs have been fabricated using metal housings having facings permanently mounted thereto, typically by adhesive, making service, such as light source replacement, difficult or impossible. When such mock neon signs are damaged, they invariably need to be discarded and replaced.

Accordingly, there is a need for an attractive, cost-effective alternative to neon signage that permits easy service and replacement of parts.

### SUMMARY OF THE INVENTION

A sign housing is disclosed adapted to receive a mock neon sign assembly. In one embodiment, the sign housing includes a plurality of sides operatively coupled to one another and to a rear panel in order to define an interior recess.

Preferably, the housing in accordance with the present invention is formed from a moldable polymer, such as by way of vacuum forming techniques. In one embodiment, the sign housing comprises two pieces including a first piece comprising the sides and the rear panel, and a second (back) piece shaped to meet the peripheral edges of the sides of the first piece. After assembly of the two pieces the assembly is preferably die cut to form a smooth edge at the junction of the two pieces.

The sign housing preferably includes a plurality of stand-offs disposed on the rear panel and at least one aperture disposed through the rear panel.

The housing is preferably employed to provide structural support to a mock neon sign, the mock neon sign including a rear board having a light source, a middle panel overlying the rear board and including one or more shaped areas having configurations that complement the arrangement of the light source, and a front panel overlying the middle panel including a corresponding shaped area that permits light from the aforementioned light source to pass therethrough.

In an alternate embodiment an assembly in accordance with the present invention comprises a housing including a plurality of slots and primary and secondary stand-offs, or bosses; a middle panel including a plurality of tabs and posts; a rear board including openings positioned to permit passage of the middle panel posts therethrough when positioning the middle panel over the rear board. In a preferred embodiment at least one of said posts includes a recess adapted to receive an end of a primary stand-off, eliminating or minimizing “play” between respective ends of a stand-off and post. Alternatively, a recess is formed in at least one stand-off to receive an end of a post. In a most preferred embodiment a rear panel of said housing includes and opening formed therein to accommodate passage of wiring or a wiring module for connection to a power supply. A power supply for an assembly in accordance with the invention may include a battery which can be mounted in various locations as will be recognized by one skilled in the art.

A method of assembling a mock neon sign in accordance with the present invention is also disclosed.

### BRIEF DESCRIPTION OF THE DRAWINGS

For the purposes of discussion, there are forms shown in the drawing for the purposes of discussion, it being understood, however, that the invention is not limited to the precise arrangements and instrumentalities shown.

FIG. 1 is a perspective view of a sign housing in accordance with one or more aspects of the present invention;

FIG. 2 is a front view of the sign housing of FIG. 1;

FIG. 3 is a rear view of the sign housing of FIG. 1;

FIGS. 4-7 are side views of the sign housing of FIG. 1;

FIG. 8 is a perspective view illustrating how a mock neon sign may be disposed within the sign housing in accordance with one or more aspects of the present invention;

FIG. 9 is a perspective view of a sign housing in accordance with one or more aspects of the present invention;

FIG. 10 is a perspective view of one embodiment of a panel device in accordance with one or more aspects of the present invention;

FIG. 11 is a perspective view of one embodiment of a feature of a panel device in accordance with one or more aspects of the present invention; and

FIG. 12 is a perspective view of one embodiment of a rear board in accordance with one or more aspects of the present invention

### DETAILED DESCRIPTION OF THE PREFERRED EMBODIMENTS

In the following description, for purposes of explanation, specific numbers, materials and configurations are set forth in order to provide a thorough understanding of the invention. It will be apparent, however, to one having ordinary skill in the art, that the invention may be practiced without these specific details. In some instances, well-known features may be omitted or simplified so as not to obscure the present invention. Furthermore, reference in the specification to “one embodiment” or “an embodiment” means that a particular feature, structure or characteristic described in connection with the embodiment is included in at least one embodiment of the invention. The appearances of the phrase “in one embodiment” in various places in the specification are not necessarily all referring to the same embodiment.

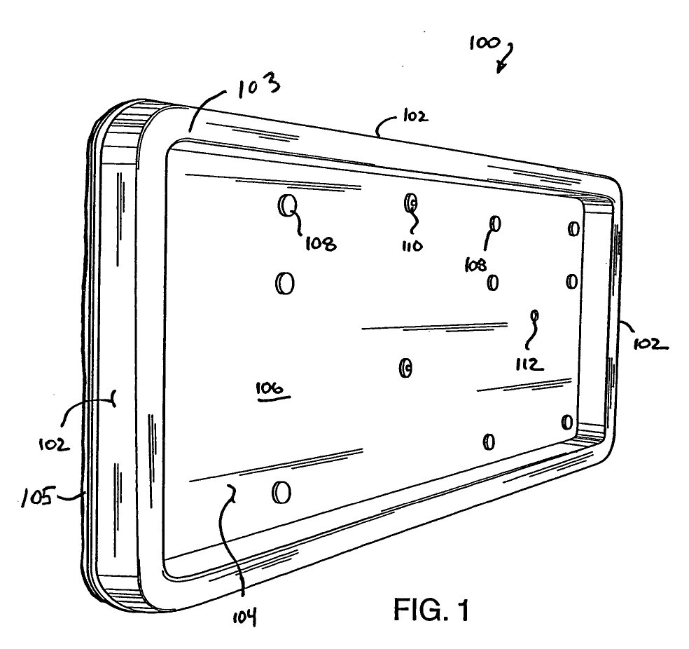

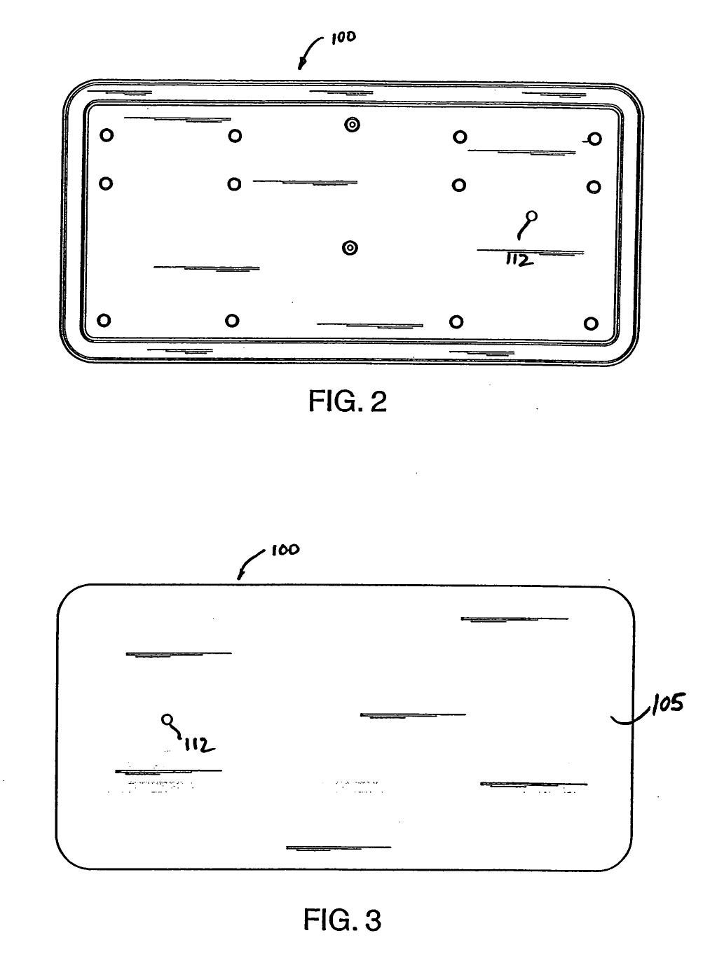

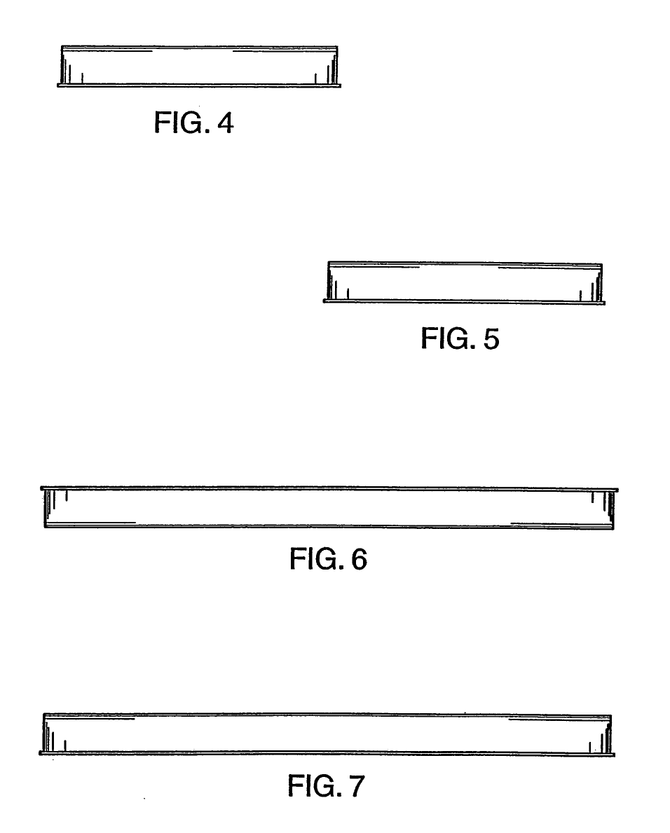

As shown in FIGS. 1-8, a sign housing 100 is illustrated as being of a generally rectangular construction, although it is understood that the sign housing 100 may take on any desired shape in order to receive a mock neon sign assembly. In this particular embodiment of the invention, the sign housing 100 includes a plurality of sides 102 that are operatively coupled to one another and to a rear panel 104 in order to define an interior recess 106 of the sign housing 100.

Preferably, the housing 100 is formed from a moldable polymer, such as by way of vacuum forming techniques. More preferably, the sign housing 100 includes a first, preferably thermoformed piece 103 comprising the sides 102 and the rear panel 104, and a second (back) piece 105 that is shaped to meet the peripheral edges of the sides 102 as best seen in FIG. 3. Back piece 105 is preferably a unitary sheet as shown in FIG. 3; however back piece 105 may comprise a frame type construction, but it is desired that the edges of back piece 105 are coextensive with the edges of sides 102. The back piece 105 is preferably solvent bonded to the first piece 103 at a flange of each. Back piece 105 may be bonded to the first piece 103 by sonic or electronic welding. The assembled first and back pieces 103, 105 are preferably die cut to form a smooth edge.

Alternatively, as would be recognized by one of skill in the art, back piece 105 and first piece 103 may be fabricated such that they can be mechanically connected, such as by snap fitting, such as but not limited to by forming a rim on the periphery of one piece and a complementary groove on the periphery of the other piece.

The sign housing 100 preferably includes a plurality of stand-offs 108 disposed on the rear panel 104. The stand-offs 108 are illustrated as having a generally circular construction, although as will become apparent to one of ordinary skill in the art, the stand-offs 108 may take on any suitable shape. In addition, one or more of the stand-offs 108 may include a depression 110 in order to facilitate operative assembly features in connection with the mock neon sign, which will be discussed later in this description.

The sign housing 100 also preferably includes at least one aperture 112 disposed through the rear panel 104 and, if present, back piece 105. As best seen in FIGS. 1 and 3, the aperture 112 provides a passageway from the recess area 106, through the rear panel 104, to a back area of the sign housing 100. The utility of the aperture 112 will be discussed hereinbelow. The aperture 112 may be formed during the die cut process described above or may be drilled, punched or otherwise formed at any time.

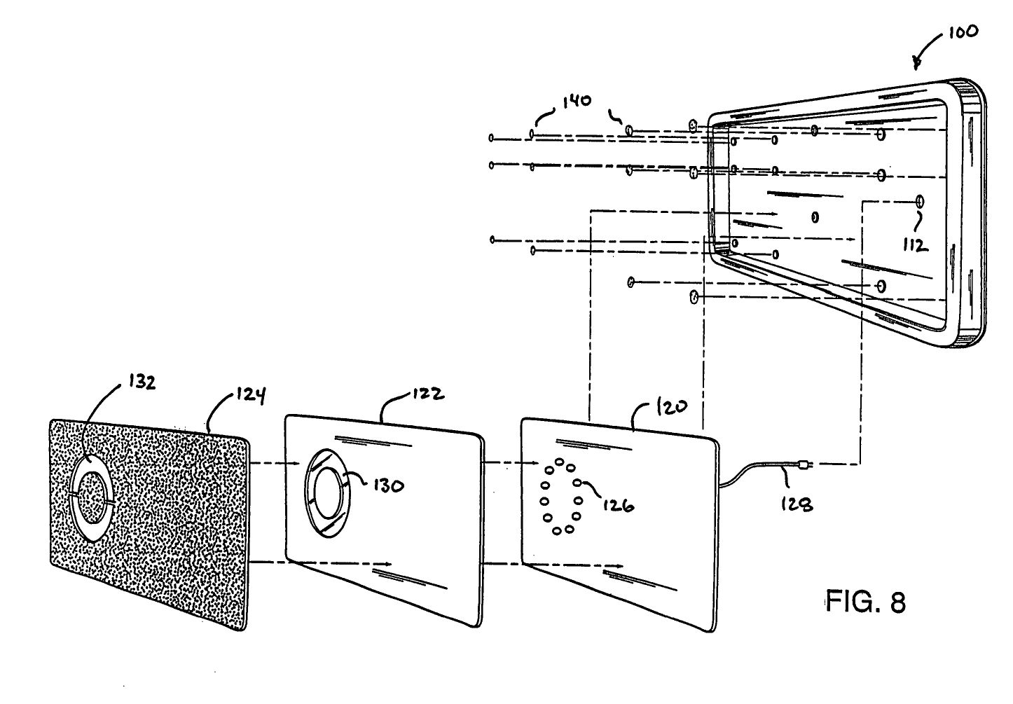

With reference to FIG. 8, the sign housing 100 is preferably employed to provide structural support to a mock neon sign. The mock neon sign includes three basic elements, namely: a rear board 120, a middle panel 122, and a front panel 124. The rear board 120 includes a light source such as but not limited to a plurality of lamps 126 that are disposed in a desirable configuration, such as an “O”. It is noted that the lamps 126 may be arranged to achieve any desirable configuration. The lamps 126 receive electric power from a suitable source, such as 120 volt, 60 Hz wall power or a battery. In accordance with the known techniques, the lamps 126 may be AC or DC lamps and, therefore, suitable power conditioning circuitry may be employed to provide the requisite power characteristics to the lamps 126. Assuming, however, that the source is wall power, the mock neon sign preferably includes a cord 128 that extends from the rear board 120. Preferably, cord 128 is fed through opening 112 as shown. In another embodiment electric power is supplied via a battery (not shown) a space for which may be provided in any suitable location on or in the assembly.

The middle panel 122 overlies the rear board 120 and includes one or more shaped areas 130 having configurations that complement the arrangements of the lamps 126. Here, one shaped area 130 is illustrated, which is in a generally circular configuration to match the arrangement of the lamps 126. Preferably, the shaped area 130 includes a generally translucent (or clear) polymer material that is shaped to mechanically receive the lamps 126 while also permitting light from the lamps 126 to pass therethrough. In one embodiment the panel 122 is vacuum-formed plastic fabricated to have the appearance of neon light tubing even when not illuminated. Most preferably, all or part of the middle panel 122 is fabricated of a specially formulated polymer. An example of such a polymer is commercially available from Primex Plastics Corp. of Garfield, N.J.

The front panel 124 overlies the middle panel 122 and includes a corresponding shaped area 132 that permits the light from the lamps 126 to pass therethrough. Remaining portions of the front panel 124 are preferably opaque in order to mask light. Suitable materials for front panel 124 include but are not limited to foam, paper, cardboard, metal, laminates, plastic, blown PVC and the like suitable for masking a desired degree of light. Preferably front panel 124 is fabricated of foam rubber. Front panel 124 may be formed of multiple pieces to accommodate particular signage.

The assembly of the rear board 120, the middle panel 122 and the front panel 124 is preferably coupled to the sign housing 100 by way of the stand-offs 108. In particular, some adhesive material 140 may be used to connect the rear board 120 to the rear panel 104 of the sign housing 100. In addition, the cord 128 may pass through the aperture 112 such that it may readily be connected to a source of power.

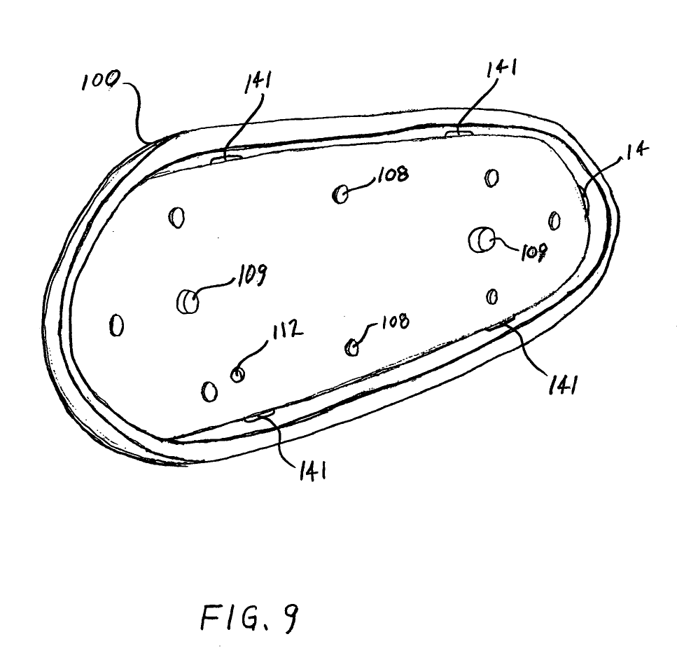

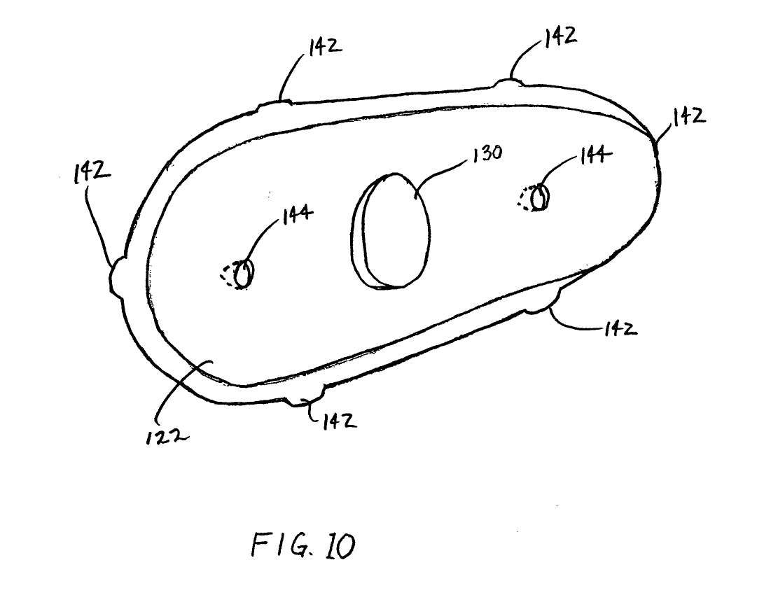

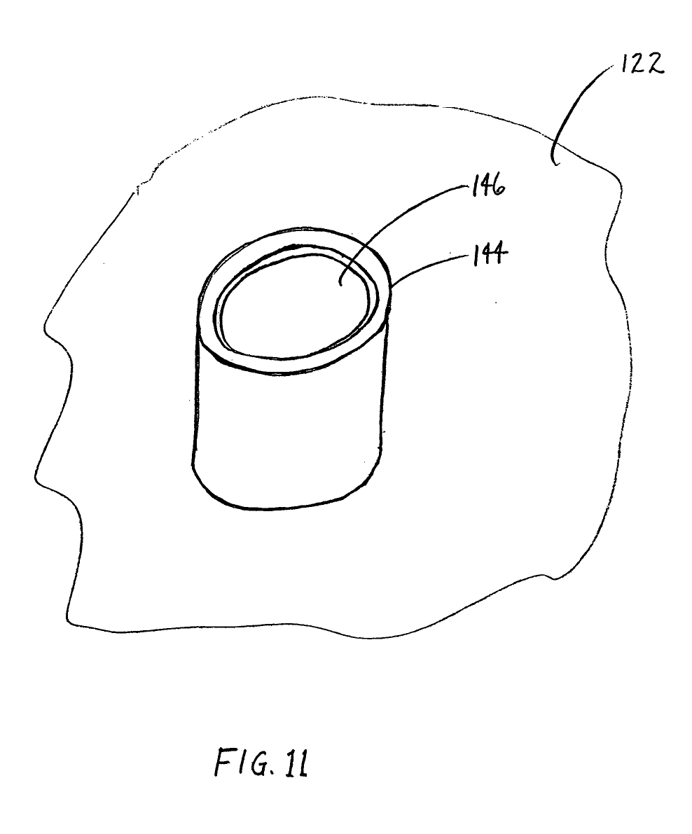

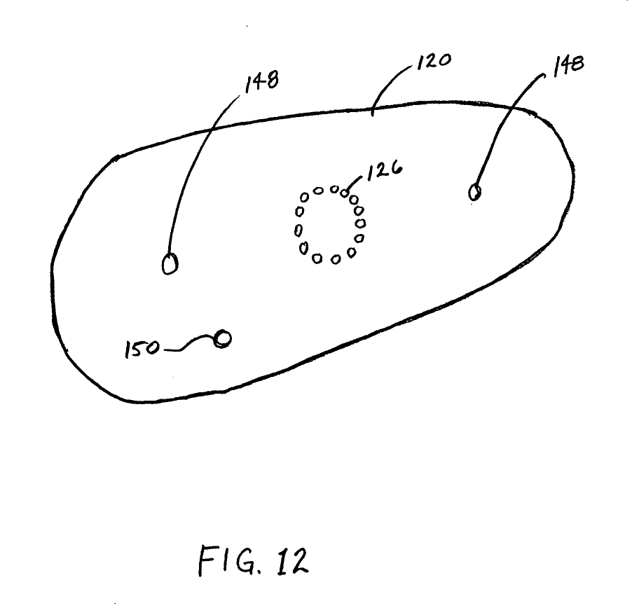

Now referring to FIGS. 9-12 in an alternate embodiment an assembly in accordance with the present invention is disclosed. Housing 100 includes slots 141 and primary stand-offs 109 and secondary stand-offs 108. Primary stand-offs 109 extend further outward from housing 100 than secondary stand-offs 108. Middle panel 122 further includes tabs 142 and posts 144, and rear board 120 includes openings 148 formed therein. Tabs 142 of middle panel 122 are adapted to engage slots 141 of housing 100. Posts 144 preferably extend from a rear face of middle panel 122 to contact complementary primary stand-offs 109 of housing 100. Openings 148 of rear board 120 are positioned to permit passage of posts 144 therethrough when positioning the middle panel 122 over rear board 120. Now referring to FIG. 11 in one embodiment post 144 include a recess 146 adapted to receive an end of primary stand-off 109. In this embodiment “play” between respective ends of stand-off 109 and post 144 is minimized or eliminated. Alternatively, a recess is formed in stand-off 109 to receive an end of post 144. Preferably post 144 is sized to fit snugly in opening 148. Rear board may include a wiring module 150 adapted to fit in opening 112 of housing 100.

A method of assembly according to at least one aspect of the present invention comprises applying adhesive to at least some of stand-offs 109 and 108 of housing 100, inserting rear board 120 over stand-offs 109 and 108, stand-offs 108 supporting a back side of rear board 120 and stand-offs 109 aligning with openings 148 of rear board 120, inserting middle panel 122 over rear board 120, aligning tabs 142 of the middle panel 122 with the slots 141 of housing 100 and the posts 144 with primary stand-offs 109, and inserting a front panel 124 over said middle panel.

Although the invention herein has been described with reference to particular embodiments, it is to be understood that these embodiments are merely illustrative of the principals and applications of the present invention. It is therefore to be understood that numerous modifications may be made to the illustrative embodiments and that other arrangements may be devised without departing from the spirit and scope of the present invention as defined by the appended claims.

1. A housing adapted to receive a mock neon sign assembly comprising a plurality of sides operatively coupled to one another and to a rear panel defining an interior recess and at least one stand-off dimensioned to meet a complementary post of an element of a mock neon sign assembly.

2. The housing according to claim 1 wherein said housing is formed of a moldable polymer.

3. The housing according to claim 1 comprising a first piece comprising the sides and the rear panel, and at least one piece extending from a rear side of said rear panel shaped to meet peripheral edges of the sides of the first piece.

4. The housing according to claim 1 further comprising a plurality of stand-offs extending from a front side of the rear panel.

5. The housing according to claim 1 further comprising at least one aperture formed in said rear panel.

6. An assembly comprising a housing according to claim 1, said assembly comprising a rear board having a light source, a middle panel comprising at least one shaped area having a configuration complementary to an arrangement of the light source, said middle panel adapted to be disposed over said rear board and a front panel adapted to be disposed over said middle panel, the front panel comprising a shaped area complementary to an area that permits light from the aforementioned light source to pass therethrough.

7. The assembly according to claim 6, said housing comprising at least one slot and said middle panel comprising at least one tab wherein said slot is dimensioned to accommodate said tab.

8. The assembly according to claim 6, said housing comprising at least one stand-off, said middle panel comprising at least one post, said rear board comprising at least one aperture formed therein located to accommodate the middle panel post.

9. The assembly according to claim 8, at least one of said posts comprising at least one recess formed thereon adapted to receive an end of at least one stand-off.

10. The assembly according to claim 6, at least one of said stand-offs comprising at least one recess formed thereon adapted to receive an end of at least one post.

11. The assembly according to claim 6 comprising mounting means adapted to accommodate a power supply.

12. The assembly according to claim 11 wherein said power supply is a battery.

13. The assembly according to claim 6 said front panel comprising at least one foam mask.

14. A method of assembling a mock neon sign in accordance with claim 8 comprising applying adhesive to at least one of said stand-offs, inserting said rear board over said stand-offs, aligning at least one of said stand-offs with an opening formed in said rear board, inserting said middle panel over the rear board, aligning at least one tab of the middle panel with at least one slot of said housing, aligning at least one of said posts with at least one of said stand-offs, and inserting said front panel over said middle panel.

15. A method of assembling a housing for a mock neon sign comprising providing a first piece comprising a plurality of sides operatively coupled to one another and to a rear panel defining an interior recess, providing at least one additional piece having peripheral edges dimensioned to at least meet peripheral edges of the sides of said first piece, and connecting said peripheral edges of a back side of said first piece to the at least one additional piece.

16. The method according to claim 15 further comprising removing any material of said at least one additional piece that extends beyond the peripheral edges of said first piece.

17. The method according to claim 15 further comprising providing a plurality of stand-offs extending from a front side of the rear panel.

18. The method according to claim 15 further comprising forming at least one aperture in said rear panel.

19. The method according to claim 18 further comprising forming at least one aperture in said at least one additional piece such that said aperture is coextensive with said aperture in said rear panel.

20. The method according to claim 15 further comprising providing at least one slot in said interior recess proximate a junction of said rear wall and at least one of said sides.
